(19) United States
(12) Patent Application Publication
(10) Pub. No.: US 2013/0156930 A1
(43) Pub. Date: Jun. 20, 2013

(54) GREEN TEA BEVERAGE PACKED IN CONTAINER AND METHOD OF MANUFACTURING THE SAME

(71) Applicants: Masami Sasame, Makinohara-shi (JP); Kenji Shimaoka, Makinohara-shi (JP); Junko Iida, Makinohara-shi (JP); Kazunobu Tsuru, Makinohara-shi (JP)

(72) Inventors: Masami Sasame, Makinohara-shi (JP); Kenji Shimaoka, Makinohara-shi (JP); Junko Iida, Makinohara-shi (JP); Kazunobu Tsuru, Makinohara-shi (JP)

(73) Assignee: Ito En, Ltd.

(21) Appl. No.: 13/818,612

(22) PCT Filed: Aug. 31, 2010
(86) PCT No.: PCT/JP2010/064832

§ 371 Date: Feb. 22, 2013

(51) Int. Cl. A23F 3/16

(52) U.S. Cl. CPC A23F 3/163
USPC 426/597; 426/495

(57) ABSTRACT

The present invention provides a green tea beverage packed in a container that has strong fire odor (savory flavor) and flavor sustention, and has less coarse taste, has transparency, and allows delicious drinking even in a cold state.

The green tea beverage packed in a container of the present invention has a sugar concentration, which is a sum of the reducing sugar concentration and a non-reducing sugar concentration, being 50 ppm to 250 ppm, a ratio of the non-reducing sugar concentration to the reducing sugar concentration (non-reducing sugar/reducing sugar) being 8 to 24, and a particle size of cumulative 90% by mass of particles (D90) being 3500 μm or more.

### TECHNICAL FIELD

The present invention relates to a green tea beverage packed in a container that contains a green tea extraction liquid that is extracted from a green tea as a major component, which is filled into a plastic bottle, a can or the like.

### BACKGROUND ART

In connection with the flavor of a green tea beverage, various inventions have been suggested from various view points such as elevation of original odor and good taste of a green tea, or catering for consumers' tastes, and the like.

For example, Patent Document 1 discloses a method of manufacturing a water-soluble tea extract that gives flavor by adding enzymes to a tea extraction residue and hydrolyzing it.

Patent Document 2 discloses a tea beverage that is obtained by two-step extraction of performing extraction with tea leaves in 80 to 100° C. hot water for 30 to 90 seconds and cooling the extract to 30 to 50° C. by adding cold water, and then performing extraction for 120 to 300 seconds, wherein the tea beverage has high odor in the same degree as that of a high temperature-extracted tea beverage, and deep delicious taste, strong richness, and weak sourness in the same degree as that of a low temperature-extracted tea beverage.

Patent Document 3 discloses a low temperature extraction method of preventing generation of off flavor, which is so-called retort smell that occurs at the time of sterilization treatment.

Patent Document 4 discloses a method of mixing extraction liquids of refined green tea (Gyokuro tea) and deep-steamed tea to improve the flavor.

In addition, Patent Document 5 discloses a method of manufacturing a product that has a balance of delicious taste and aroma by using at least 2 kinds or more of extraction water obtained through low temperature extraction and high temperature extraction.

Patent Document 6 suggests a method in which live tea leaves are roasted by an oven, whereby to boost the unique aroma of fired tea by heating and improve tea flavor.

Patent Document 7 suggests a method of manufacturing a green tea beverage packed in a tight-sealed container by blending a green tea extraction liquid, which is extracted from tea leaves (green tea) with the use of low temperature aqueous media such as 45 to 70° C. ion-exchanged water, with an extract extracted from live tea leaves with the use of hot water, in which the extract is blended as it is or in the form of a concentrate, and/or in the dried form, which is intended to provide a green tea beverage packed in a tight-sealed container, which has freshly-brewed tea aroma and balanced flavor.

In addition, Patent Document 8 discloses a method of manufacturing a green tea beverage that is excellent in flavor, and has good balance of aroma components, and creates no unpleasant sediments, which comprises two-divided tea extraction steps in which one step is to obtain a pressure-extraction liquid by subjecting green tea leaves to pressurized extraction (step A) and the other step is to obtain an ordinary pressure-extraction liquid by subjecting green tea leaves to ordinary pressure extraction and then to fine filtration (step B), and comprises a mixing step of mixing the pressure-extraction liquid and the ordinary pressure-extraction liquid obtained in each step in a mixing ratio that is determined on the basis of the weight of the live tea leaves (step C).

Patent Document 9 discloses a method of manufacturing a green tea beverage that appropriately has unique green tea odor, delicious taste, and richness, exhibits light greenish yellow of the color tone, is translucent, has no sediments even with long period storage. In the method, a green tea is subjected to extraction with warm water at a pH of 8.0 to 10.0, the resulting extraction liquid is adjusted to have a pH of 5.5 to 7.0 and a turbidity of 83 to 93% in terms of T % at 660 nm, and then it is filled into a package container which is then tightly sealed.

In addition, Patent Document 10 discloses a method of manufacturing a tea beverage that is excellent in flavor, particularly excellent in nutritious taste, which comprises (i) a step of bringing tea leaves into contact with saturated steam, to promote opening of the tea leaves in the low temperature extraction step, (ii) a step of subjecting the above-treated tea leaves to extraction using low temperature water, to obtain an extraction liquid, and (iii) a step of subjecting the above-mentioned extraction liquid to sterilization treatment.

Patent Documents 11 and 12 disclose a beverage packed in a container of which astringent taste and bitter taste are suppressed, in which the beverage packed in a container is obtained by blending a green tea extract containing high concentration of catechin with carbohydrate in a suitable ratio.

Patent Document 13 discloses a method of manufacturing a green tea beverage packed in a container that produces no sediments even with long period storage and is suitable for sale as a warm product. The method comprises an adsorption step of adding silica to a tea extraction liquid so that sediments components of the tea extraction liquid are adsorbed onto the silica and a kieselguhr filtration step of performing kieselguhr filtration with the use of acid-treated kieselguhr.

### PRIOR ART DOCUMENT

### Patent Document

Patent Document 1: Japanese Patent Application Laid-Open (JP-A) No. H4-228028
Patent Document 2: JP-A No. H6-303904
Patent Document 3: JP-A No. H6-343389
Patent Document 4: JP-A No. H8-126472
Patent Document 5: JP-A No. H11-56242
Patent Document 6: JP-A No. H11-262359
Patent Document 7: JP-A No. 2001-258477
Patent Document 8: JP-A No. 2001-286260
Patent Document 9: JP-A No. 2005-130734
Patent Document 10: JP-A No. 2007-117006
Patent Document 11: Japanese Patent No. 3590051
Patent Document 12: Japanese Patent No. 4136922
Patent Document 13: Japanese Patent No. 4015631

### DISCLOSURE OF THE INVENTION

### Problems to be Solved by the Invention

Along with popularization of a green tea beverage, particularly, a green tea beverage packed in a container, consumer taste and drinking situations have also become diversified and a green tea beverage packed in a container that has unique taste and characteristic odor is demanded.

A green tea beverage contains water-insoluble solid contents such as a polysaccharide and a protein, and extraction residues, and appears turbid from these components when the green tea beverage is filled into a transparent container, resulting that the appearance is not favorable although it has no problem in quality. Filtration of the green tea beverage to remove them allows a beverage that is transparent and has refreshing flavor, but lowers odor and concentration feeling.

To resolve such problems, the present invention provides a new green tea beverage packed in a container, which has strong fire odor (savory odor) and sustained odor, has small coarse taste, and is transparent, and allows delicious drinking even in a cold state.

### Means for Solving the Problems

The green tea beverage packed in a container of the present invention is characterized in that the sugar concentration, which is the sum of the reducing sugar concentration and the non-reducing sugar concentration, is 50 to 250 ppm, the ratio of the non-reducing sugar concentration to the reducing sugar concentration (non-reducing sugar/reducing sugar) is 8 to 24, and the particle size of cumulative 90% by mass of particles (D90) is 3500 μm or more.

The green tea beverage packed in a container of the present invention makes it possible to obtain a new green tea beverage packed in a container that has strong fire odor (savory odor) and sustained odor, has small coarse taste, has transparency, and allows delicious drinking even in a cold state, by adjustment of the sugar concentration, which is the sum of the reducing sugar concentration and the non-reducing sugar concentration, the concentration ratio of the non-reducing sugar to the reducing sugar, and the particle size of cumulative 90% by mass of particles (D90).

### MODE FOR CARRYING OUT THE INVENTION

Hereinafter, one exemplary embodiment of the green tea beverage packed in a container of the present invention will be explained. However, the present invention is not limited to this exemplary embodiment.

The present green tea beverage packed in a container is a beverage obtained by filling a container with a liquid containing an extraction liquid or an extract that is obtained by extraction of a green tea as a major component. Examples of the liquid include a liquid comprising only an extraction liquid that is obtained by extraction of a green tea, a liquid obtained by diluting the extraction liquid, a liquid obtained by mixing the extraction liquids with each other, a liquid obtained by adding an additive to any of the above-mentioned liquids, or a liquid obtained by dispersing those dried of any of the above-mentioned liquids.

The “major component” encompasses a meaning that containing of other components within a range of not interrupting the functions of the major component is acceptable. At this time, the content ratio of the major component is not specified, but an extraction liquid or an extract that is obtained by extraction of a green tea, preferably takes up 50% or more by mass, particularly 70% or more by mass, and even more particularly 80% or more by mass (including 100%) in the solid content concentration in the beverage.

In addition, the kind of the green tea is not particularly limited. For example, examples of the green tea include broadly teas that are classified as a non-fermented tea such as a steamed tea, a decocted tea, a refined green tea, a green powdered tea, a coarse tea, a bead green tea, an oven-roasted tea, and a Chinese green tea, and the green tea also encompasses blends of 2 kinds or more of the above. In addition, cereals such as a brown rice, a flavor such as jasmine, and the like may be also added thereto.

One exemplary embodiment of the green tea beverage packed in a container of the present invention (referred to as “the present green tea beverage packed in a container”) is characterized in that the concentration of sugars that are the sum of reducing sugars and non-reducing sugars is 50 ppm to 250 ppm, the concentration ratio of the non-reducing sugar to the reducing sugar (non-reducing sugar/reducing sugar) is 8 to 24, and the particle size of cumulative 90% by mass of particles (D90) is 3500 μm or more.

The reducing sugar is a sugar that shows reducing character, and forms an aldehyde group and a ketone group in an alkaline solution. The reducing sugar referred to in the present invention is glucose, fructose, cellobiose or maltose.

The non-reducing sugar is a sugar that does not show reducing character, and the non-reducing sugar referred to in the present invention represents sucrose, stachyose or raffinose.

When the concentration (hereinafter, referred to as the sugar concentration) of sugars that are the sum of reducing sugars and non-reducing sugars is 50 ppm to 250 ppm, the beverage maintains a balance of the taste and the odor, has sweet taste and richness, and has small coarse taste and bitter astringent taste, etc. as the aftertaste even in drinking in a state stored for a long period at normal temperature, or in a cold state.

From such viewpoint, the sugar concentration is preferably 60 ppm to 230 ppm, and particularly preferably 70 ppm to 200 ppm.

In adjustment of the sugar concentration to the above-described range, the adjustment may be performed by suitably adjusting the conditions for the dry (fire) process or extraction of the tea leaves. For example, if the dry (fire) process of the tea leaves is performed strongly, the sugars are decomposed and decrease. In addition, if the tea leaves are extracted at a high temperature for a long time, the sugars are decomposed and decrease. Therefore, the sugar concentration may be adjusted by the dry (fire) conditions and the extraction conditions of the tea leaves.

At this time, although the adjustment may be performed by addition of sugars, this has a fear of collapsing original flavor balance of a green tea beverage, so the adjustment is preferably achieved not by addition of sugars, but by adjustment of conditions for obtaining a tea extraction liquid, and in addition, by mixing of the tea extraction liquids with each other, or by addition of a tea extract, or the like.

In addition, when the ratio of the non-reducing sugar concentration to the reducing sugar concentration (non-reducing sugar/reducing sugar) is 8 to 24, the odor note when the green tea beverage is put into the mouth and the fire odor through the nose are excellent, and thus the fire odor is present in drinking even in a cold state, which allows delicious drinking.

From such viewpoint, the ratio of the non-reducing sugar concentration relatively to the reducing sugar concentration (non-reducing sugar/reducing sugar) is preferably 9 to 23.5, and particularly preferably 12 to 20.

Adjustment of the ratio of the non-reducing sugar concentration to the reducing sugar concentration to the above-described range is achieved by suitably adjusting the conditions for the dry (fire) process or the conditions for extraction of the tea leaves. For example, if tea leaves are subjected to the dry (fire) process, first, reducing sugars decrease, and then non-reducing sugars decrease. Therefore, with strong dry (fire) process performed on tea leaves and short time extraction at high temperature, the ratio of the non-reducing sugar/reducing sugar can be elevated.

At this time, although the adjustment may be performed by addition of sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of total catechins in the present green tea beverage packed in a container is preferably 180 ppm to 600 ppm.

The concentration of the total catechins is more preferably 200 ppm to 580 ppm, and further preferably 250 ppm to 500 ppm.

If the catechin concentration is too high, the odor becomes obscure, and thus when the odor particularly has importance, the concentration of the total catechins is preferably 480 ppm or less.

At this time, the total catechins mean total 8 kinds including catechin (C), gallocatechin (GC), catechin gallate (Cg), gallocatechin gallate (GCg), epicatechin (EC), epigallocatechin (EGC), epicatechin gallate (ECg) and epigallocatechin gallate (EGCg), and the concentration of the total catechins means the value of the sum of the concentrations of the 8 kinds of catechins.

In adjustment of the concentration of the total catechins to the above-described range, the concentration of the total catechins may be adjusted by extraction conditions.

At this time, although the adjustment may be performed by addition of catechins, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of the electron-localized catechins in the present green tea beverage packed in a container is preferably 155 ppm to 550 ppm.

The concentration of the electron-localized catechins is more preferably 180 ppm to 500 ppm, and particularly further preferably 200 ppm to 450 ppm.

The “electron-localized catechin” referred to as in the present invention is a catechin that has a triol structure (a structure having 3 OH groups adjacent to the benzene ring), and is considered such that localization of the electric charge occurs when ionized. Specifically, the “electron-localized catechin” includes epigallocatechin gallate (EGCg), epigallocatechin (EGC), epicatechin gallate (ECg), gallocatechin gallate (GCg), gallocatechin (GC), catechin gallate (Cg) and the like.

In adjustment of the concentration of the electron-localized catechins to the above-described range, the concentration of the electron-localized catechins may be adjusted with the extraction conditions. However, the concentration of the electron-localized catechin easily changes with the extraction time and the temperature, and thus the conditions that the temperature is too high or the extraction time is too long is not preferable from the view point of maintaining of the aroma of the beverage.

At this time, although the adjustment may be performed by addition of the electron-localized catechin, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The ratio of the electron-localized catechin concentration relatively to the sugar concentration (electron-localized catechin/sugars) in the present green tea beverage packed in a container is preferably 1.8 to 5.0. When the ratio is within this range, the present green tea beverage packed in a container becomes a beverage that has a balance of astringent taste and sweet taste, has spreading fire odor, and further is refreshing even in drinking in a cold state.

From such viewpoint, the ratio of the electron-localized catechin concentration to the sugar concentration (electron-localized catechin/sugars) is more preferably 2.0 to 4.0, and particularly further preferably 2.2 to 3.5.

In adjustment of the ratio of the electron-localized catechin concentration to the sugar concentration to the above-described range, the ratio may be adjusted with the extraction conditions. However, although the extraction rate of catechin increases at a high temperature, sugars are likely to be decomposed at a higher temperature state, and thus the extraction time is preferably short.

At this time, although the adjustment may be performed by addition of the electron-localized catechin and the sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

The concentration of the soluble solid content (Brix) in the present green tea beverage packed in a container is preferably 0.16% to 0.50%. The soluble solid content is a sucrose-converted value of the soluble solid content in the beverage.

The concentration of the soluble solid content in the present green tea beverage packed in a container is more preferably 0.20% to 0.45%, and further preferably 0.25% to 0.40%.

In adjustment of the concentration of the solid content soluble in the beverage to the above-described range, the concentration may be suitably adjusted with adjustment of the amount of the tea leaves and the extraction conditions.

The ratio of the sugar concentration to the concentration of the soluble solid content (Brix) in the present green tea beverage packed in a container (sugars/(soluble solid content (Brix)×100)) is preferably 3.1 to 6.3. The ratio of the sugar concentration to the concentration of the soluble solid content (Brix) is more preferably 3.3 to 5.8, and particularly further preferably 4.0 to 5.5.

In adjustment of the ratio of the sugar concentration relatively to the concentration of the soluble solid content (Brix) to the above-described range, the ratio may be adjusted by increasing the tea leaf amount whereby to elevate the concentration of the soluble solid content, and by drying conditions for the raw tea leaves.

At this time, although the adjustment may be performed by addition of the sugars, this has a fear of collapsing the balance of a green tea beverage, so the adjustment is preferably performed by adjustment of conditions for obtaining a tea extraction liquid, and in addition, by mixing of the tea extraction liquids with each other, or by addition of a tea extract, or the like.

By the fact that the particle size of cumulative 90% by mass of particles (D90) is 3500 μm or more in the present green tea beverage packed in a container, it is possible to prepare a beverage that has small fine particles and excellent odor note and is transparent.

From such viewpoint, the particle size of cumulative 90% by mass (D90) of particles is preferably 3800 μm or more, and particularly preferably 3950 μm or more.

In adjustment of the particle size of the cumulative 90% by mass (D90) of particles to the above-described range, D90 may be adjusted by performing a dry (fire) process for raw materials, by filtration of the extraction liquid, or the like. Examples of the filtration include ultrafiltration, fine filtration, precise filtration, inverse osmotic membrane filtration, electrodialysis, filtration by a membrane such as a biofunctional membrane, and filter cake filtration using a porous media. Among them, adjustment by filter cake filtration using either one or both of a filter media largely containing silica content and a porous media such as kieselguhr is preferable from the viewpoints of productivity and adjustment of the particle size.

In the present green tea beverage packed in a container, the particle size of cumulative 10% by mass of particles (D10) is preferably 400 μm or more. This range makes it possible to prepare a beverage having small coarse taste and being transparent.

From such viewpoint, the particle size of cumulative 10% by mass of particles (D10) is more preferably 500 μm or more and particularly preferably 600 μm or more.

In adjustment of the particle size of cumulative 10% by mass of particles (D10) to the above-described range, D10 may be adjusted by performing a dry (fire) process, filtration of the extraction liquid, or the like. Examples of the filtration include ultrafiltration, fine filtration, precise filtration, inverse osmotic membrane filtration, electrodialysis, filtration by a membrane such as a biofunctional membrane, and filter cake filtration using a porous media. Among them, adjustment by filter cake filtration using either one or both of a filter media largely containing silica content and a porous media such as kieselguhr is preferable from the viewpoint of productivity and adjustment of the particle size.

The particle sizes of the above-described D90 and D10 are those measured for the size of particles of water-insoluble solid content such as a polysaccharide and a protein, extraction residue, etc. in the present green tea beverage packed in a container, or the size of particles that are precipitated by adsorption of other components to them as a nucleus.

The pH of the present green tea beverage packed in a container is preferably 6.0 to 6.5 at 20° C. The pH of the present green tea beverage packed in a container is more preferably 6.0 to 6.4, and particularly further preferably 6.1 to 6.3.

The concentrations of the reducing sugar, the non-reducing sugar, the total catechins, and the electron-localized catechin described above can be measured by a calibration curve method and the like using a high performance liquid chromatogram (HPLC) and the like.

In addition, the above-described D90 and D10 can be measured by a laser diffraction type equipment for measuring particle size distribution or the like.

(Container)

A container filled with the present green tea beverage packed in a container is not particularly limited. For example, a bottle made of plastic (so-called PET bottle), a can of metal such as steel and aluminum, a bottle, a paper container and the like may be used, and particularly, a transparent container such as a PET bottle and the like may be preferably used as the container.

(Manufacturing Method)

The present green tea beverage packed in a container may be manufactured by, for example, selecting raw materials for tea leaves, and suitably adjusting conditions for a dry (fire) process and extraction for the tea leaves, whereby to adjust the sugar concentration, which is the sum of the reducing sugar concentration and the non-reducing sugar concentration in the beverage, to 50 ppm to 250 ppm, to adjust the ratio of the non-reducing sugar concentration to the reducing sugar concentration (non-reducing sugar/reducing sugar), to 8 to 24, and to adjust the particle size of cumulative 90% of by mass of particles (D90) to 3500 μm or more. For example, the present green tea beverage packed in a container can be manufactured by preparing an extraction liquid, which is obtained by subjecting tea leaves to a dry (fire) process at 285° C. to 330° C. and subjecting the tea leaves at high temperature extraction for a short time, and a conventional general green tea extraction liquid, i.e., an extraction liquid that is obtained by subjecting tea leaves to a dry (fire) process at 80° C. to 150° C. and subjecting the tea leaves to low temperature extraction for a long time; filtering; and then blending them in a suitable ratio. With regard to the dry process, the dry process is preferably the “firing” referred to as in the tea processing, i.e., a step of bring out the unique odor of a green tea. For example, the dry process is preferably performed in a type such as the shelf type and the drum type with dry hot wind, direct firing, far infrared ray or the like, which is used alone or in combination in view of fire odor and sweet odor. However, the invention is not limited to such manufacturing method.

As described above, by performing the dry (fire) process to tea leaves, first, the reducing sugars decrease, and then the non-reducing sugars decrease. Accordingly, by adjustment of the conditions for the dry (fire) process, the sugar concentration and the value of the non-reducing sugar/reducing sugar may be adjusted.

In addition, in adjustment of the particle size, the dry (fire) process may be performed on tea leaves, but filter cake filtration using either one or both of a filter media largely containing silica content and a porous media such as kieselguhr is preferably performed for the extraction liquid.

(Kieselguhr Filtration)

In one example of the kieselguhr filtration, an auxiliary layer (pre-coat) formed of kieselguhr is formed onto a filtration carrier surface, and a neat liquid (tea extraction liquid as an unfiltered liquid) is sent to the above-mentioned auxiliary layer while a kieselguhr filtering agent is injected (body feed) to the neat liquid (tea extraction liquid as an unfiltered liquid) as necessary.

Herein, the “pre-coat” is an auxiliary layer having a thickness of several mm that is formed on the surface of a filtration carrier (for example, metal-made net (leaf), thick filter paper (filter pad), laminated metal ring (candle), ceramic tube (candle) and the like) by dispersing an auxiliary agent in a clear liquid and circulating the resulting liquid before filtration manipulation, which makes it possible to filter the suspending solid content and improve the clarification degree of the filtrate.

As the kieselguhr used in the present invention, kieselguhr that is used as a filtration aid may be used, such as those obtained by trituration and dry treatment of a raw ore of kieselguhr, those obtained by further burning or fusing agent-burning treatment to those obtained by the trituration and dry treatment, and the like. However, kieselguhr filtration aid having 0.05 to 0.2 Darcy may be preferably used. By using the kieselguhr filtration aid having 0.05 to 0.2 Darcy, it is possible to manufacture a clearer tea beverage packed in a container. The “kieselguhr filtration aid having 0.05 to 0.2 Darcy” means a kieselguhr filtration aid of which the Darcy permeability K is within a range of 0.05 to 0.2. The “Darcy permeability K” is one of the indexes that represent permeability of a filtration aid, and may be calculated by a water permeation method or an air permeation method. At the moment, the “Darcy” is so generally used that a kieselguhr filtration aid having designated Darcy value may be purchased.

In addition, as the kieselguhr used in the present invention, a kieselguhr from which iron is eluted and removed by acid treatment is preferably used. This is because the iron has an influence on the taste in the green tea beverage, and also becomes a cause for browning. The method of the acid treatment for kieselguhr is not particularly limited. For example, methods may be adopted such as a method in which kieselguhr and acidic water are added to a mixing bath and then agitated, a method in which acid is added to a mixture of kieselguhr and water in a mixing bath and then agitated, and a method in which in kieselguhr and acidic water are brought into contact in any method, and then solid-liquid isolated, and then washed with water, to use kieselguhr in an aqueous suspension state or wet state as it is. By using the kieselguhr in an aqueous suspension state or wet state as it is, the iron content eluted from kieselguhr can be further lowered. Herein, the acidic water includes acidic water having less than 7.0 pH, preferably 1 to 5 pH (acidic aqueous solution), for example, an aqueous solution of an organic acid such as citric acid, lactic acid and acetic acid, an inorganic acid such as phosphoric acid, nitric acid and hydrochloric acid, and the like.

Other filtration aids such as silica gel, pearlite and cellulose may be mixed and used with the kieselguhr.

(Silica Adsorption)

With regard to the silica adsorption, silica is added to a tea extraction liquid to bring the tea extraction liquid into contact with silica, whereby to cause sediment components in the tea extraction liquid to be selectively adsorbed to silica and the added silica may be removed in a later step.

As the silica to be added, silica (silicon dioxide; SiO₂), and in addition, a silica-containing material that contains silica as a major component (taking up 50% or more of the total mass) may be used.

The silica (silicon dioxide; SiO₂) may be either crystalline or non-crystalline. In addition, the silica may be a natural product or a synthetic product. When the silica is a synthetic product, silica that is manufactured by any synthetic method such a dry method (gas phase method), a wet method (water glass method; comprising a gel type and a precipitation type) and a sol-gel method, may be used.

The silica-containing material includes, for example, silicate, clay mineral such as kieselguhr, crystal, quartz and the like, which are natural products.

By addition of silica to the tea extraction liquid to bring the tea extraction liquid into contact with silica, it is possible to selectively adsorb sediment components contained in the tea extraction liquid, particularly partial protein and polysaccharide that form a secondary sediment, by silica, whereby to reduce the concentration of the sediment components in the tea extraction liquid.

The addition amount of silica is preferably 0.5 to 20 times and particularly 1 to 10 times the amount of the raw materials of the green tea to be subjected to extraction (mass of tea leaves).

It is possible to adjust adsorption performance of silica by controlling the addition amount, and in addition, the particle size, the pore size, and electric charge of silica, and hydroxy groups existing on the silica surface (silanol group), whereby to adjust the kind and the amount of the protein and the polysaccharide that are adsorbed and removed, whereby to adjust the flavor of the green tea beverage.

Regarding specific adsorption method, for example, silica may be added to a tea extraction liquid and agitated, or silica may be added to a tea extraction liquid after coarse filtration, and the tea extraction liquid with silica is sent to the next step whereby to bring the tea extraction liquid into contact with silica in the liquid-sending process. Alternatively, silica may be added several times as divided to be dispersed for adsorption.

At this time, it is preferable that after the addition of silica to the tea extraction liquid, the tea extraction liquid is in contact with silica while being cooled to 20 to 40° C. If the tea extraction liquid is cooled to 20° C. or less, there is a fear that cream down occurs, causing reduction in adsorption performance of silica. On the other hand, if the temperature is higher than 40° C., the tea extraction liquid may change by the heat and the flavor is likely to be harmed.

In addition, the tea extraction liquid to be added with silica is preferably adjusted to be in a weak acidic region (pH 4.5 to 5.5). Adjustment to the weak acidic region suppresses change of catechins. It should be noted that if the pH is lower than 4.5, there is a fear that cream down occurs, causing in reduction in adsorption performance of silica.

In order to remove silica from the tea extraction liquid, a silica filtration step of removing silica may be additionally separately performed. Alternatively, the silica may be removed in centrifugal isolation, kieselguhr filtration, or other filtration steps following the adsorption step.

(Explanation on Terms)

The “green tea beverage” in the present invention means a beverage containing a tea extraction liquid or a tea extract that is obtained from tea extraction, as a major component.

In addition, the “green tea beverage packed in a container” means a green tea beverage that is packed in a container, and also means a green tea beverage that may be provided for drinking without dilution.

When “X to Y” (X and Y are any numbers) is expressed in the present specification, it encompasses the meaning of “X or more and Y or less,” and also the meaning of “preferably greater than X” and “preferably less than Y” unless otherwise stated.

### EXAMPLES

Hereinafter, Examples of the present invention will be explained. However, the present invention is not limited to this Example.

The “reducing sugar concentration” in Examples means a total concentration of glucose, fructose, cellobiose and maltose, and the “non-reducing sugar concentration” means a total concentration of sucrose, stachyose and raffinose.

<Evaluation Test 1>

Extraction Liquids A to D described below were prepared, and using these Extraction Liquids, green tea beverages of Examples 1 to 4 and Comparative Examples 1 to 9 were prepared, and sensory evaluations therefor were performed.

(Extraction Liquid A)

Tea leaves (Yabukita species, first flush tea produced in Kagoshima Prefecture) after plucking were subjected to Aracha process, and to a dry process (fire process) with a rotation drum type firing machine under the conditions of 85° C. of the setting temperature and 20 minutes of the dry time. The tea leaves were subjected to extraction under the conditions of 50 g of the tea leaves, 10 L of 70° C. hot water, and 4 minutes of the extraction time. This extraction liquid was filtered with a stainless mesh (20 mesh) to remove the tea grounds, and then further filtered with a stainless mesh (80 mesh), to obtain Extraction Liquid A.

(Extraction Liquid B)

Tea leaves (Yabukita species, first flush tea produced in Kagoshima Prefecture) after plucking were subjected to Aracha process, and to a dry process (fire process) with a rotation drum type firing machine under the conditions of 85° C. of the setting temperature and 20 minutes of the dry time. The tea leaves were subjected to extraction under the conditions of 110 g of the tea leaves, 10 L of 80° C. hot water and 5 minutes of the extraction time. This extraction liquid was filtered with a stainless mesh (20 mesh) to remove the tea grounds, and then further filtered with a stainless mesh (80 mesh), to obtain Extraction Liquid B.

(Extraction Liquid C)

Tea leaves (Yabukita species, third flush tea produced in Miyazaki Prefecture) after plucking was subjected to Aracha process with an oven-roasting method, and to a dry process (fire process) with a rotation drum type firing machine under the conditions of 285° C. of the setting temperature and 12 minutes of the dry time. The tea leaves were subjected to extraction under the conditions of 140 g of the tea leaves, 10 L of 90° C. hot water, and 4.5 minutes of the extraction time. This extraction liquid was filtered with a stainless mesh (20 mesh) to remove the tea grounds, and then further filtered with a stainless mesh (80 mesh), to obtain Extraction Liquid C.

(Extraction Liquid D)

Tea leaves (Yabukita species, third flush tea produced in Miyazaki Prefecture) after plucking was subjected to Aracha process with an oven-roasting method, and to a dry process (fire process) with a rotation drum type firing machine under the conditions of 285° C. of the setting temperature and 8 minutes of the dry time. The tea leaves were subjected to extraction under the conditions of 50 g of the tea leaves, 10 L of 90° C. hot water, and 3 minutes of the extraction time. This extraction liquid was filtered with a stainless mesh (20 mesh) to remove the tea grounds, and then further filtered with a stainless mesh (80 mesh), to obtain Extraction Liquid D.

(Filtration)

Each of the Extraction Liquids A to D was divided into two containers, either one was Nell-filtered with use of a Nell fabric to prepare Extraction Liquids A1 to D1, and the other one was Nell-filtered with use of Nell fabric, and then further kieselguhr-filtered with body-feeding 0.2% by mass of kieselguhr (“P5” manufactured by Showa Chemical Industry Co., Ltd.) relatively to the real liquid onto a filter plate in which 2 mm thick pre-coat was formed on a filtration carrier (FILTER PAD, manufactured by Advantec MFS) with use of 700 g of the kieselguhr per 1 m², to prepare Extraction Liquids A2 to D2.

(Measurement for Particle Size)

1/10 amount of each extraction liquid described above was weighed, added with ascorbic acid in 400 ppm, and then added with sodium bicarbonate to adjust pH to 6.2, and added with ion-exchanged water to adjust the total amount to 500 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C. For the solution, the particle size of cumulative 90% by mass (D90) and the particle size of cumulative 10% by mass (D10) were immediately measured using a laser diffraction equipment for measuring particle size distribution (“SALD-2100” manufactured by Shimadzu Corporation). The results of the measurements are shown in Table 1 described below.

TABLE 1

| | D10 | D90 |
|---|---|---|
| A1 | 2.8 | 25.6 |
| A2 | 1260.9 | 7955.2 |
| B1 | 2.5 | 24.0 |
| B2 | 1255.8 | 7948.3 |
| C1 | 3.0 | 28.9 |
| C2 | 1258.9 | 7945.3 |
| D1 | 3.1 | 27.5 |
| D2 | 1261.3 | 7958.7 |

(Blending)

Extraction Liquids A1 to D1 and A2 to D2 were blended in the ratios listed in Table 2, added with ascorbic acid in 400 ppm, and then added with sodium bicarbonate to adjust pH to 6.2, and added with ion-exchanged water to adjust the total amount to 5000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C., to prepare the green tea beverages of Examples 1 to 4 and Comparative Examples 1 to 9.

TABLE 2

| | A1 | A2 | B1 | B2 | C1 | C2 | D1 | D2 | Total |
|---|---|---|---|---|---|---|---|---|---|
| Example 1 | 20 | 45 | 5 | 0 | 0 | 0 | 0 | 30 | 100 |
| Comparative | 65 | 0 | 5 | 0 | 0 | 0 | 0 | 30 | 100 |
| Example 1 | | | | | | | | | |
| Example 2 | 0 | 0 | 15 | 0 | 0 | 65 | 20 | 0 | 100 |
| Comparative | 0 | 0 | 0 | 15 | 65 | 0 | 20 | 0 | 100 |
| Example 2 | | | | | | | | | |
| Example 3 | 25 | 0 | 0 | 25 | 25 | 0 | 0 | 25 | 100 |
| Example 4 | 0 | 20 | 0 | 0 | 30 | 30 | 0 | 20 | 100 |
| Comparative | 40 | 0 | 0 | 0 | 5 | 0 | 55 | 0 | 100 |
| Example 3 | | | | | | | | | |
| Comparative | 0 | 40 | 0 | 0 | 0 | 5 | 0 | 55 | 100 |
| Example 4 | | | | | | | | | |
| Comparative | 0 | 0 | 50 | 25 | 0 | 0 | 5 | 20 | 100 |
| Example 5 | | | | | | | | | |
| Comparative | 5 | 0 | 0 | 0 | 0 | 95 | 0 | 0 | 100 |
| Example 6 | | | | | | | | | |
| Comparative | 0 | 0 | 5 | 5 | 10 | 10 | 35 | 35 | 100 |
| Example 7 | | | | | | | | | |
| Comparative | 0 | 100 | 0 | 0 | 0 | 0 | 0 | 0 | 100 |
| Example 8 | | | | | | | | | |
| Comparative | 0 | 0 | 0 | 0 | 100 | 0 | 0 | 0 | 100 |
| Example 9 | | | | | | | | | |

(Analysis)

Components and pH of the green tea beverages of Examples 1 to 4 and Comparative Examples 1 to 9 were measured as shown below. The results are shown in Table 3 described below.

TABLE 3

| | | Comparative | | Comparative | | | Comparative |
|---|---|---|---|---|---|---|---|
| | Example 1 | Example 1 | Example 2 | Example 2 | Example 3 | Example 4 | Example 3 |
| Non-Reducing | 9.10 | 9.10 | 23.32 | 23.32 | 14.29 | 22.03 | 16.65 |
| Sugar/Reducing | | | | | | | |
| Sugar | | | | | | | |
| Sugars | 51.9 | 51.9 | 227.0 | 227.0 | 161.6 | 176.3 | 49.0 |
| Electron-Localized | 189.7 | 189.7 | 491.6 | 491.6 | 409.8 | 378.4 | 153.1 |
| Catechin | | | | | | | |
| pH | 6.2 | 6.2 | 6.2 | 6.2 | 6.2 | 6.2 | 6.2 |
| Electron-Localized | 3.66 | 3.66 | 2.17 | 2.17 | 2.54 | 2.15 | 3.13 |
| Catechin/Sugars | | | | | | | |
| Total Catechin | 213.5 | 213.5 | 557.0 | 557.0 | 462.4 | 429.6 | 173.0 |
| (ppm) | | | | | | | |
| Brix (%) | 0.16 | 0.16 | 0.45 | 0.45 | 0.32 | 0.39 | 0.16 |
| D10 | 946.5 | 380.3 | 819.3 | 190.9 | 630.7 | 883.0 | 3.0 |
| D90 | 5973.8 | 2405.4 | 5173.5 | 1216.5 | 3990.4 | 5575.0 | 26.8 |
| Odor Note From | ◯ | X | ◯ | X | ⊚ | ◯ | X |
| The Top | | | | | | | |
| Sustention Of | ◯ | X | ◯ | Δ | ⊚ | ◯ | X |
| Residual Odor | | | | | | | |
| Concentration | ◯ | ◯ | ⊚ | ◯ | ⊚ | ◯ | Δ |
| Feeling | | | | | | | |
| Coarse Taste | ◯ | Δ | ◯ | X | ◯ | ◯ | Δ |
| Color Tone | ◯ | Δ | Δ | X | ◯ | ◯ | X |
| (Browning, etc.) | | | | | | | |
| Total Evaluation | ◯ | X | ◯ | X | ⊚ | ◯ | X |

| | Comparative | Comparative | Comparative | Comparative | Comparative | Comparative |
|---|---|---|---|---|---|---|
| | Example 4 | Example 5 | Example 6 | Example 7 | Example 8 | Example 9 |
| Non-Reducing | 16.65 | 7.89 | 26.01 | 24.28 | 1.58 | 27.30 |
| Sugar/Reducing | | | | | | |
| Sugar | | | | | | |
| Sugars | 49.0 | 235.3 | 257.3 | 108.6 | 40.3 | 268.7 |
| Electron-Localized | 153.1 | 640.1 | 519.8 | 256.2 | 184.8 | 537.4 |
| Catechin | | | | | | |
| pH | 6.2 | 6.2 | 6.2 | 6.2 | 6.2 | 6.2 |
| Electron-Localized | 3.13 | 2.72 | 2.02 | 2.36 | 4.59 | 2.00 |
| Catechin/Sugars | | | | | | |
| Total Catechin | 173.0 | 719.5 | 590.5 | 290.1 | 207.6 | 610.7 |
| (ppm) | | | | | | |
| Brix (%) | 0.16 | 0.37 | 0.53 | 0.25 | 0.14 | 0.550 |
| D10 | 1261.0 | 567.6 | 1196.1 | 631.7 | 1260.9 | 3.0 |
| D90 | 7956.6 | 3592.2 | 7549.3 | 3991.2 | 7955.2 | 28.9 |
| Odor Note From | Δ | X | Δ | X | X | X |
| The Top | | | | | | |
| Sustention Of | X | Δ | X | Δ | X | X |
| Residual Odor | | | | | | |
| Concentration | X | Δ | X | Δ | Δ | ◯ |
| Feeling | | | | | | |
| Coarse Taste | Δ | X | Δ | ◯ | Δ | X |
| Color Tone | Δ | Δ | Δ | Δ | Δ | X |
| (Browning, etc.) | | | | | | |
| Total Evaluation | X | X | X | X | X | X |

The reducing sugar concentration and the non-reducing sugar concentration were quantity-measured by a calibration curve method with manipulation of a HPLC sugar analysis equipment (manufactured by Dionex Corporation) under the conditions described below.

Column: “Carbopack PA1 φ4.6×250 mm” manufactured by Dionex Corporation

Column Temperature: 30° C.

Mobile Phase:

| | |
|---|---|
| Phase A | 200 mM NaOH |
| Phase B | 1000 mM Sodium Acetate |
| Phase C | Ultrapure water |

Flow Rate: 1.0 mL/min

Injection Amount: 25 μL

Detection: “ED50 gold electrode” manufactured by Dionex Corporation

The electron-localized catechin concentration and the total catechin concentration were quantity-measured by a calibration curve method with manipulation of a high performance liquid chromatogram (HPLC) under the conditions described below.

Column: “Xbridge shield RP18 φ3.5×150 mm” manufactured by Waters Corporation

Column Temperature: 40° C.

Mobile Phase:

| | |
|---|---|
| Phase A | Water |
| Phase B | Acetonitrile |
| Phase C | 1% phosphoric acid |

Flow Rate: 0.5 mL/min

Injection Amount: 5 μL

Detection: “UV230 nm UV detector” manufactured by Waters Corporation

The pH was measured with “F-24,” which is a pH meter manufactured by HORIBA, Ltd., according to an ordinary method.

The concentration of the soluble solid content (Brix) was measured with “DD-7” manufactured by ATAGO CO LTD.

(Evaluation Item)

Using the green tea beverages of Examples 1 to 4 and Comparative Examples 1 to 9, odor note from the top, sustention of residual odor, concentration feeling, coarse taste, and color tone (browning and the like) were evaluated.

(Evaluation Test)

The green tea beverages of Examples 1 to 4 and Comparative Examples 1 to 9 were kept at 25° C. for 3 months, and cooled to 5° C. With use of them, the tests were performed. First, 20 persons of general consumers drinking green teas at ordinary times observed the liquid color of each beverage visually. Then, each beverage was tasted, and given scores by the evaluations described below. The evaluations were performed wherein “⊚ (double circile)” indicates 3.5 or more, “◯ (circle)” indicates 3 or more and less than 3.5, “Δ (triangle)” indicates 2 or more and less than 3, and “X (cross)” indicates 1 or more and less than 2 of the average points of the 20 persons. The results thereof are shown in Table 3 described above.

<Odor Note from the Top>

Specially Strong=4

Strong=3

Present=2

Usual=1

<Sustention of Residual Odor>

Specially good=4

Good=3

Present=2

Sensed=1

<Concentration Feeling>

Specially Strong=4

Strong=3

Present=2

Weak=1

<Coarse Taste>

Specially good=4

Good=3

Usual=2

Bad=1

<Color Tone (Browning, etc.)>

Specially good=4

Good=3

Slightly Red=2

Red=1

(Total Evaluation)

The average points of the above-described five evaluation tests were calculated, and the total evaluations were performed wherein “⊚ (double circle)” indicates 3.5 or more, “◯ (circle)” indicates 3 or more and less than 3.5, “Δ (triangle)” indicates 2 or more and less than 3, and “X (cross)” indicates 1 or more and less than 2 of the average point.

For any of Examples 1 to 4, excellent results were obtained, of which the total evaluation was “◯ (circle)” or better.

On the other hand, for Comparative Examples 1 to 9, the results were not preferable, of which the evaluation was “X (cross)”

From the results of Comparative Examples 1 and 2, it was found that if D90 is small, the odor note becomes worse and also the coarse taste is felt. From the results of Comparative Examples 3 and 4, it was found that if the sugar concentration decreases, results of the evaluations become generally worse. From the results of Comparative Examples 5 and 7, if the value of the non-reducing sugar/reducing sugar increases or decreases, it was found that the odor note and the concentration feeling are suppressed. From the results of Comparative Examples 6, 8 and 9, it was found that if the sugar concentration and the value of the non-reducing sugar/reducing sugar increase or decrease together, it was found that there is no sustention of odor note.

From these results, it is assumed that the ranges of the sugar concentration being 50 ppm to 250 ppm, the ratio of the non-reducing sugar concentration to the reducing sugar concentration (non-reducing sugar/reducing sugar) being 8 to 24, and D90 being 3500 μm or more, are ranges that allow odor note from the top, sustention of residual odor, concentration feeling, coarse taste and color tone (browning and the like) to become better, and it was discovered that a green tea beverage of which these items are in these ranges, has strong fire odor (savory odor), and sustained odor, and has small coarse taste and has transparency.

<Evaluation Test 2>

Extraction Liquids E and F described below were prepared, and using these Extraction Liquids, green tea beverages of Examples 5 to 9 were prepared, and sensory evaluations with age were performed.

(Extraction Liquid E)

Tea leaves (Yabukita species, third flush tea produced in Kagoshima Prefecture) after plucking was subjected to Aracha process, and to a dry process (fire process) with a rotation drum type firing machine under the conditions of 310° C. of the setting temperature and 8 minutes of the dry time. The tea leaves were extracted under the conditions of 70 g of the tea leaves, 10 L of 90° C. hot water and 2.5 minutes of the extraction time. This extraction liquid was filtered with a stainless mesh (20 mesh) to remove the tea grounds, and then further filtered with a stainless mesh (80 mesh). To the filtrate, silica (non-crystalline hydrous silica: “Mizukasorb” manufactured by MIZUSAWA INDUSTRIAL CHEMICALS, LTD.) was added to the tea leaves in two fold amount, and then the filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further kieselguhr-filtered with body-feeding 0.2% by mass of acid-treated kieselguhr relatively to the real liquid onto a filter plate in which 2 mm thick pre-coat was formed on a filtration carrier (FILTER PAD, manufactured by Advantec MFS) with use of 700 g of the acid-treated kieselguhr per 1 m², to prepare Extraction E. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Extraction Liquid F)

Tea leaves (Yabukita species, first flush tea produced in Miyazaki Prefecture) after plucking was subjected to Aracha process with an oven-roasting method, and to a dry process (fire process) with a rotation drum type firing machine under the conditions of 330° C. of the setting temperature and 2 minutes of the dry time. The tea leaves were subjected to extraction under the conditions of 120 g of the tea leaves, 10 L of 80° C. hot water and 2 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), and then further kieselguhr-filtered with body-feeding 0.2% by mass of acid-treated kieselguhr relatively to the real liquid onto a filter plate in which 2 mm thick pre-coat was formed on a filtration carrier (FILTER PAD, manufactured by Advantec MFS) with use of 700 g of the acid-treated kieselguhr per 1 m², to prepare Extraction Liquid F. At this time, the kieselguhr used was “RADIOLITE #300” manufactured by Showa Chemical Industry Co., Ltd. that was dipped in 40 fold amount of sulfuric acid solution (pH 1.5), and stood for 2 hours at ambient temperature with agitation, and then washed with water to pH 5 of the filtrate, and then dried with a rotation type drum.

(Measurement for Particle Size)

For each of the Extraction Liquids E and F, the particle size of cumulative 90% by mass (D90) and the particle sized of cumulative 10% by mass (D10) were measured in the same manner as in Evaluation Test 1 described above. The results of the measurements are shown in Table 4 described below.

TABLE 4

| | D10 | D90 |
|---|---|---|
| E | 1237.43 | 7930.10 |
| F | 1261.40 | 8000.80 |

(Blending)

Extraction Liquids E and F were blended in the ratios shown in Table 5, added with ascorbic acid in 400 ppm, and then added with sodium bicarbonate to adjust pH to 6.2, and added with ion-exchanged water to adjust the total amount to 10000 mL. This liquid was subjected to UHT sterilization (135° C., 30 seconds), cooled in a plate, and filled into a transparent plastic container (PET bottle) at 85° C. to obtain a green tea beverage packed in a container. Then, the cap portion was over-turn sterilized for 30 seconds, and the solution was immediately cooled to 20° C., to prepare the green tea beverages of Examples 5 to 9.

The results of the measurements for the components of the green tea beverages of Examples 5 to 9 are shown in Table 6 described below. Each component and pH was measured in the same manner as in Evaluation Test 1 described above.

TABLE 5

| | E | F | Total |
|---|---|---|---|
| Example 5 | 70 | 30 | 100 |
| Example 6 | 40 | 60 | 100 |
| Example 7 | 20 | 80 | 100 |
| Example 8 | 0 | 100 | 100 |
| Example 9 | 100 | 0 | 100 |

TABLE 6

| | | Example 5 | Example 6 | Example 7 | Example 8 | Example 9 |
|---|---|---|---|---|---|---|
| Electron-Localized | | 4.11 | 3.08 | 2.40 | 1.72 | 5.13 |
| Catechin/Sugars | | | | | | |
| Sugar Concentration | | 95.4 | 85.6 | 79.0 | 72.4 | 105.3 |
| Non-Reducing Sugar/Reducing | | 11.95 | 10.39 | 9.34 | 8.30 | 13.52 |
| Sugar | | | | | | |
| Electron-Localized Catechin | | 415.5 | 290.8 | 207.7 | 124.5 | 540.2 |
| pH | | 6.2 | 6.2 | 6.2 | 6.2 | 6.2 |
| Total Catechin | | 472.2 | 330.4 | 236.0 | 141.5 | 613.9 |
| Brix (%) | | 0.26 | 0.28 | 0.29 | 0.30 | 0.24 |
| D10 | | 1249.60 | 1253.60 | 1262.30 | 1254.30 | 1239.50 |
| D90 | | 7934.30 | 7992.50 | 8001.20 | 7998.10 | 7920.80 |
| Change Over | Browning | ◯ | ◯ | ◯ | ⊚ | Δ |
| Time | Degree | | | | | |
| | Flavor Note | ◯ | ◯ | ◯ | ◯ | Δ |
| | Through The | | | | | |
| | Nose | | | | | |
| | Aftertaste | ◯ | ⊚ | ◯ | Δ | Δ |
| | (Bitterness And | | | | | |
| | Remaining way) | | | | | |
| | Deteriorated | ◯ | ⊚ | ⊚ | Δ | Δ |
| | Smell | | | | | |
| | Balance Of | ⊚ | ⊚ | ◯ | Δ | Δ |
| | Flavor | Good | Good balance | Refreshing | Slight | Slight |
| | | aftertaste and | of taste and | taste and | aftertaste | aftertaste |
| | | odor through | odor and | suitably | remaining | remaining |
| | | the nose to | spreading odor | spreading | and | and |
| | | have no | in the mouth to | odor in the | spreading | spreading |
| | | astringent | have no bitter | mouth | odor in the | odor in the |
| | | taste and bitter | astringent | sensed to | mouth that | mouth that |
| | | taste as | taste as | have no | is weaker | is but |
| | | aftertaste | aftertaste | astringent | than the | weaker than |
| | | | | taste and | others | the others |
| | | | | bitter taste as | | |
| | | | | aftertaste | | |

| | | | | | |
|---|---|---|---|---|---|
| Total Evaluation | ◯ | ⊚ | ◯ | Δ | Δ |

(Evaluation Item)

The green tea beverages of Examples 5 to 9 were kept at 25° C. for 6 months, and the browning degree, the flavor note through the nose, the aftertaste (bitterness and the remaining way), the deteriorated smell and the balance of flavor were evaluated.

(Evaluation Test)

The green tea beverages of Examples 5 to 9 were cooled to 5° C. With use of them, the tests were performed. In the same manner as in the test mentioned above, 20 persons of general consumers drinking green teas at ordinary times, observed the liquid color of each beverage visually, and evaluated the liquid color in comparison with those of the previous time. Then, each beverage was tasted, and given scores by the evaluations described below. The evaluations were performed wherein “⊚ (double circle)” indicates 3.5 or more, “◯ (circle)” indicates 3 or more and less than 3.5, “Δ (triangle)” indicates 2 or more and less than 3, and “X (cross)” indicates 1 or more and less than 2 of the average points of the 20 persons. The results thereof are shown in Table 6 described above.

<Browning Degree>

No difference=4

Slightly Red=3

Red=2

Brightly Changed Red=1

<Odor Note Through the Nose>

Specially good=4

Good=3

Present=2

No Feeling=1

<Aftertaste (Bitterness and Remaining Way)>

Sensed and Remained=4

Sensed and Slightly Remained=3

Slightly Sensed=2

Not Sensed=1

<Deteriorated Smell>

Not Sensed=4

Slightly Sensed=3

Sensed=2

Strong=1

<Balance of Flavor>

Specially good=4

Good=3

Slightly Collapsed=2

Collapsed=1

(Total Evaluation)

The average points of the five evaluation tests of the browning degree, the odor note through the nose, the aftertaste (bitterness and the remaining way), the deteriorated smell and the balance of flavor were calculated, and the total evaluations were performed wherein “⊚ (double circle)” indicates 3.5 or more, “◯ (circle)” indicates 3 or more and less than 3.5, “Δ (triangle)” indicates 2 or more and less than 3, and “X (cross)” indicates 1 or more and less than 2 of the average point.

For any of Examples 5 to 7, excellent results were obtained, of which the total evaluation was “◯ (circle)” or better.

On the other hand, for Examples 8 and 9, the results were “Δ (triangle)”, which were slightly inferior to the results of Examples 5 to 7.

From the results of Example 8, it was found that if the value of the electron-localized catechin/sugars is lowered, the aftertaste (bitterness and the remaining way), the deteriorated smell and the balance of flavor become worse. From the results of Example 9, it was found that if the value of the electron-localized catechin/sugars increases, the total items become worse.

From these results, it is assumed that the range of the electron-localized catechin/sugars being 1.8 to 5.0, is a range that allows small browning degree and good odor through the nose, aftertaste (bitterness and the remaining way), deteriorated smell and balance of flavor even with age, and it was discovered that a green tea beverage of which the electron-localized catechin/sugars is in this range, has strong fire odor (savory odor), and sustained odor, and has small coarse taste and has transparency even with age.

1. A green tea beverage packed in a container of which a sugar concentration, which is the sum of a reducing sugar concentration and a non-reducing sugar concentration, is 50 ppm to 250 ppm, a ratio of the non-reducing sugar concentration to the reducing sugar concentration (non-reducing sugar/reducing sugar) is 8 to 24, and a particle size of cumulative 90% by mass of particles (D90) is 3500 μm or more.

2. The green tea beverage packed in a container according to claim 1, wherein the ratio of an electron-localized catechin concentration to a sugar concentration (electron-localized catechin/sugars) is 1.8 to 5.0.

3. A method of manufacturing a green tea beverage packed in a container comprising steps of;
adjusting a sugar concentration in a green tea beverage, which is the sum of a reducing sugar concentration and a non-reducing sugar concentration, to 50 ppm to 250 ppm;
adjusting a ratio of the non-reducing sugar concentration to the reducing sugar concentration (non-reducing sugar/reducing sugar) to 8 to 24; and
adjusting a particle size of cumulative 90% by mass of particles (D90) to 3500 μm or more.

4. The method of manufacturing a green tea beverage packed in a container according to claim 3 comprising steps of:
adjusting the particle size of the cumulative 90% by mass (D90) of particles by filtration.

5. The method of manufacturing a green tea beverage packed in a container according to claim 4 comprising steps of:
adjusting the particle size of the cumulative 90% by mass of particles (D90) by filter cake filtration using either one or both of a filter media containing silica content and a porous media.

6. A method for improving flavor of a green tea beverage packed in a container comprising steps of:
adjusting a sugar concentration in a green tea beverage, which is the sum of a reducing sugar concentration and a non-reducing sugar concentration, to 50 ppm to 250 ppm;
adjusting a ratio of the non-reducing sugar concentration to the reducing sugar concentration (non-reducing sugar/reducing sugar) to 8 to 24; and
adjusting a particle size of cumulative 90% by mass of particles (D90) to 3500 μm or more.
